(19) United States
(12) Patent Application Publication
(10) Pub. No.: US 2026/0274250 A1
(43) Pub. Date: Sep. 17, 2026

(54) DRIVING ASSISTANCE APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kento OISHI, Tokyo (JP); Shimpei HIGASHINO, Atsugi-shi (JP)

(21) Appl. No.: 19/560,727

(22) Filed: Mar. 9, 2026

(30) Foreign Application Priority Data
Mar. 11, 2025 (JP) 2025-038283

(51) Int. Cl. B60W 30/09; B60W 10/18; B60W 30/095; B60W 50/00; B60W 50/14

(52) U.S. Cl. CPC B60W 30/09; B60W 10/18; B60W 30/0956; B60W 50/0097; B60W 50/14; B60W 2420/403; B60W 2420/408; B60W 2520/10; B60W 2540/18; B60W 2556/35

(57) ABSTRACT

A driving assistance apparatus includes: a fusion unit that fuses first and second objects into a fusion object; a speed calculation unit that calculates a first speed of the first object and a second speed of the second object; a speed determination unit that determines whether the first speed is lower than a first threshold, and determines whether the second speed is lower than a second threshold; a turning determination unit that determines whether a mobile object is turning; and a collision prediction unit. When (i) the mobile object is turning and (ii) the first speed is lower than the first threshold or the second speed is lower than the second threshold, the collision prediction unit predicts that no collision will occur between the fusion object and the mobile object even if a movement trajectory of the fusion object and a movement trajectory of the mobile object intersect each other.

### CROSS-REFERENCE TO RELATED APPLICATION

This application is based on and claims priority from Japanese Patent Application No. 2025-038283 filed on Mar. 11, 2025, the entire contents of which are hereby incorporated by reference into this application.

### BACKGROUND

### 1 Technical Field

The present disclosure relates to driving assistance apparatuses.

### 2 Description of Related Art

Various techniques have been proposed for detecting objects around an own vehicle and avoiding collisions between the objects and the own vehicle. For example, Japanese Patent Application Publication No. JP 2014-122873 A discloses a technique for detecting objects around an own vehicle using two sensors, i.e., a radar and a monocular camera. When an object detected by the radar and an object detected by the monocular camera satisfy a predetermined condition, these objects are determined to be the same object. Such a process is also referred to as “object fusion”. By fusing objects detected by two sensors, the accuracy of the object detection is improved in comparison with the case of detecting objects using only one sensor. A fusion object, into which these objects are fused, is used for collision prediction of the own vehicle.

### SUMMARY

However, in object fusion, even when objects detected by the respective sensors are in fact two different objects, they may be determined to be the same object. This is referred to as “erroneous fusion”. Erroneous fusion is likely to occur for objects that appear at an edge of the angle of view of a sensor while the own vehicle is turning. This is because such objects have been detected by the sensors only for a short time with the turning of the own vehicle and therefore there is only a small amount of available information on these objects. When erroneously-fused objects are used for collision prediction, the accuracy of the collision prediction may be lowered. Accordingly, there is room for improvement in collision prediction in situations where erroneous fusion is likely to occur. Such a problem is common not only to cases where a radar and a monocular camera are used but also to cases where other sensors are used. Moreover, such a problem is common not only to vehicles but also to any mobile objects.

The present disclosure has been accomplished in view of the above problem found by the inventors of the present application.

According to the present disclosure, there is provided a driving assistance apparatus for a mobile object. The mobile object has a first sensor and a second sensor configured to detect objects around the mobile object. The driving assistance apparatus includes: a fusion unit configured to fuse a first object detected by the first sensor and a second object detected by the second sensor and output a fusion object into which the first and second objects are fused; a speed calculation unit configured to calculate both a first speed that is a speed of the first object and a second speed that is a speed of the second object; a speed determination unit configured to determine whether the first speed is lower than a first threshold that is a predetermined threshold and determine whether the second speed is lower than a second threshold that is another predetermined threshold; a turning determination unit configured to determine whether the mobile object is turning; and a collision prediction unit configured to predict, based on a movement trajectory of the fusion object outputted from the fusion unit and a movement trajectory of the mobile object, whether a collision will occur between the fusion object and the mobile object. Moreover, when (i) it is determined by the turning determination unit that the mobile object is turning and (ii) it is determined by the speed determination unit that one of a condition that the first speed is lower than the first threshold and a condition that the second speed is lower than the second threshold is satisfied, the collision prediction unit predicts that the fusion object and the mobile object will not collide with each other even if the movement trajectory of the fusion object and the movement trajectory of the mobile object intersect each other.

With the above configuration, it is possible to prevent, during turning of the mobile object for which erroneous fusion is likely to occur, an erroneous prediction that the fusion object and the mobile object will collide with each other.

### BRIEF DESCRIPTION OF THE DRAWINGS

FIG. 1 is a block diagram illustrating the overall configuration of a driving assistance apparatus according to an exemplary embodiment.

FIG. 2 is a diagram for explaining erroneous object fusion.

FIG. 3 is a flowchart illustrating steps of a collision prediction process performed by the driving assistance apparatus for a fusion object.

### DESCRIPTION OF EMBODIMENTS

Hereinafter, a driving assistance apparatus 1 according to an exemplary embodiment will be described with reference to the drawings.

### Overview of Driving Assistance Apparatus 1

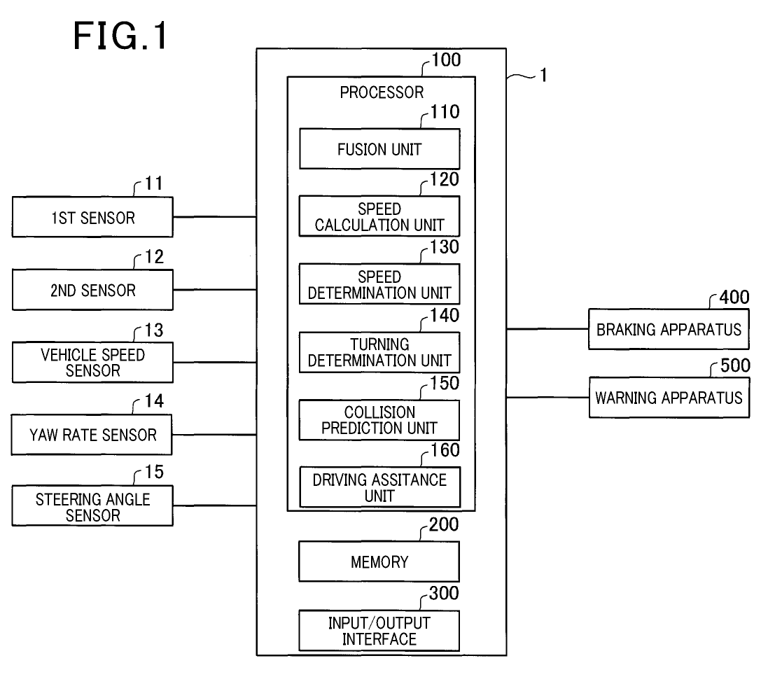

FIG. 1 illustrates the overall configuration of the driving assistance apparatus 1 which is installed and used in a vehicle. The driving assistance apparatus 1 fuses objects detected by a plurality of sensors installed in the vehicle, and predicts whether a collision will occur between the vehicle and a fusion object into which the objects are fused. Further, when a collision between the vehicle and the fusion object is predicted, the driving assistance apparatus 1 causes a braking force to be applied to the vehicle and issues a warning to a driver of the vehicle. The application of the braking force is realized by operation of a braking apparatus 400 which will be described later. The issuance of a warning is realized by a warning apparatus 500 which will also be described later. Hereinafter, the vehicle in which the driving assistance apparatus 1 is installed will be referred to as the own vehicle.

In the present disclosure, “objects” are detection targets of the sensors installed in the vehicle. Examples of objects include a pedestrian, a bicycle, an animal, a vehicle other than the own vehicle, a structure, a utility pole, a tree, a sign, and the like.

### Configurations of Sensors

As shown in FIG. 1, signals are transmitted from a plurality of sensors to the driving assistance apparatus 1 via an input/output interface (I/F) 300. The plurality of sensors shown in FIG. 1 are installed in the vehicle in which the driving assistance apparatus 1 is installed. The plurality of sensors include a first sensor 11, a second sensor 12, a vehicle speed sensor 13, a yaw rate sensor 14 and a steering angle sensor 15.

The first sensor 11 and the second sensor 12 detect objects present around the own vehicle. The first sensor 11 and the second sensor 12 may be, for example, cameras or ranging devices. Moreover, the ranging devices may be, for example, devices to which a millimeter-wave radar or LiDAR (Light Detection and Ranging) is applied. The detection ranges of the first sensor 11 and the second sensor 12 at least partially overlap each other. In the present embodiment, the first sensor 11 and the second sensor 12 are constituted of sensors of different types from each other. Specifically, the first sensor 11 is constituted of a camera, whereas the second sensor 12 is constituted of a millimeter-wave radar. Hereinafter, an object detected by the first sensor 11 will be referred to as a “first object”; and an object detected by the second sensor 12 will be referred to as a “second object”.

The vehicle speed sensor 13 generates a signal indicative of the traveling speed of the own vehicle. The vehicle speed sensor 13 may detect, for example, the rotational speed of a tire of the own vehicle. The signal generated by the vehicle speed sensor 13 is used for calculation of the traveling speed and acceleration of the own vehicle by the driving assistance apparatus 1.

The yaw rate sensor 14 generates a signal indicative of the yaw rate acting on the own vehicle. The signal generated by the yaw rate sensor 14 is used for calculation of the yaw rate of the own vehicle by the driving assistance apparatus 1.

The steering angle sensor 15 transmits a steering angle signal indicative of the steering angle of a steering wheel of the own vehicle to the driving assistance apparatus 1. The steering angle sensor 15 is mounted to a steering rod of the own vehicle. The steering angle signal is used for calculation of the steering angle and steering angular velocity of the own vehicle by the driving assistance apparatus 1.

### Configuration of Braking Apparatus 400

The braking apparatus 400 applies a braking force to the own vehicle for decelerating the own vehicle. Specifically, the braking apparatus 400 applies the braking force in accordance with an instruction from the driver of the own vehicle or an instruction from the driving assistance apparatus 1. The instruction from the driver is given using an input device such as a brake pedal. The instruction from the driving assistance apparatus 1 is given by transmission of a control signal.

### Configuration of Warning Apparatus 500

The warning apparatus 500 issues a warning to the driver of the own vehicle when a collision between the own vehicle and an object is predicted. The warning is conveyed by sound or image. The warning apparatus 500 may include, for example, a speaker, a display, or the like. The warning apparatus 500 is not limited to the aforementioned devices and may be configured with any suitable devices.

### Configuration of Driving Assistance Apparatus 1

The driving assistance apparatus 1 includes a processor 100, a memory 200 and the input/output I/F 300. In addition, the driving assistance apparatus 1 may be configured as a part of an ECU (Electronic Control Unit) that executes various types of control of the own vehicle.

By executing a program stored in the memory 200, the processor 100 functions as a fusion unit 110, a speed calculation unit 120, a speed determination unit 130, a turning determination unit 140, a collision prediction unit 150 and a driving assistance unit 160.

### Function of Fusion Unit 110

The fusion unit 110 fuses a first object detected by the first sensor 11 and a second object detected by the second sensor 12, and outputs a fusion object into which the first and second objects are fused. More specifically, the fusion unit 110 outputs the fusion object when information on the first object and information on the second object satisfy a predetermined condition. The predetermined condition may be, for example, a condition that the position of the first object and the position of the second object are close to each other. In this case, when the distance between the position of the first object detected by the first sensor 11 and the position of the second object detected by the second sensor 12 is shorter than a predetermined threshold, the fusion unit 110 regards the first object and the second object as being the same object and outputs the fusion object. Alternatively, the predetermined condition may be a condition that the shape of the first object and the shape of the second object are similar, or a condition that feature points of the first object and feature points of the second object are similar. In addition, the predetermined condition is not limited to these exemplary conditions; and any arbitrary condition may be set as the predetermined condition. The predetermined condition is stored in advance in the memory 200.

### Function of Speed Calculation Unit 120

The speed calculation unit 120 calculates a first speed that is the speed of the first object, and a second speed that is the speed of the second object. The first speed is calculated based on the detection results of the first sensor 11; and the second speed is calculated based on the detection results of the second sensor 12. For example, the first and second speeds may be calculated based on temporal changes in the positions of the first and second objects detected respectively by the first and second sensors 11 and 12. The calculated speeds are transmitted to the speed determination unit 130.

### Function of Speed Determination Unit 130

The speed determination unit 130 determines whether the first speed is lower than a first threshold that is a predetermined threshold, and determines whether the second speed is lower than a second threshold that is another predetermined threshold. Further, the speed determination unit 130 determines whether one of a condition that the first speed is lower than the first threshold and a condition that the second speed is lower than the second threshold is satisfied. In other words, the speed determination unit 130 determines whether one of the first and second objects is a stationary object. It should be noted that the term “stationary object” encompasses not only an object that is in a completely stopped state but also an object that is moving at a low speed. In addition, the low speed herein may be, for example, a speed of 1 km/h or lower. The first threshold and the second threshold may be the same value or different values from each other. For example, both the first threshold and the second threshold may be 1 km/h. In addition, the first threshold and the second threshold are not limited to 1 km/h, and may be any value. Both the first threshold and the second threshold are stored in advance in the memory 200. The determination results are transmitted to the collision prediction unit 150.

### Function of Turning Determination Unit 140

The turning determination unit 140 determines whether the own vehicle is turning. The turning determination is performed based on at least one of the turning radius, the steering angle and the steering angular velocity of the own vehicle. The turning radius is calculated based on the vehicle speed and the yaw rate of the own vehicle. The vehicle speed is calculated using the signal generated by the vehicle speed sensor 13. The yaw rate is calculated using the signal generated by the yaw rate sensor 14. The steering angle and the steering angular velocity are calculated using the steering angle signal generated by the steering angle sensor 15.

### Function of Collision Prediction Unit 150

The collision prediction unit 150 predicts whether a collision will occur between the fusion object outputted from the fusion unit 110 and the own vehicle. The prediction is performed based on a movement trajectory of the fusion object and a movement trajectory of the own vehicle. The movement trajectory of the fusion object is calculated based on the temporal change in the position of the fusion object. The movement trajectory of the own vehicle is calculated based on the traveling speed and the yaw rate of the own vehicle. When the movement trajectory of the fusion object and the movement trajectory of the own vehicle intersect each other, the collision prediction unit 150 predicts that the fusion object and the own vehicle will collide with each other. In contrast, when the movement trajectory of the fusion object and the movement trajectory of the own vehicle do not intersect each other, the collision prediction unit 150 predicts that the fusion object and the own vehicle will not collide with each other. In addition, the calculation of the movement trajectories is not limited to the above-described methods and may be performed by any suitable methods.

Moreover, in the present disclosure, when both the following first and second conditions are satisfied, the collision prediction unit 150 predicts that the fusion object and the own vehicle will not collide with each other even if the movement trajectory of the fusion object and the movement trajectory of the own vehicle intersect each other.

The first condition is that the own vehicle is determined by the turning determination unit 140 to be turning. During turning of the own vehicle, the angles of view of the first sensor 11 and the second sensor 12 change significantly. Consequently, an object that was located behind and thus hidden by another object before the turning of the own vehicle, and/or an object that was located outside the angles of view of the first sensor 11 and the second sensor 12 before the turning of the own vehicle, may be newly detected. In this case, there is only a small amount of available information on such objects because they have been detected only for a short time.

The second condition is that it is determined by the speed determination unit 130 that one of the condition that the first speed is lower than the first threshold and the condition that the second speed is lower than the second threshold is satisfied. In other words, the second condition is that one of the first and second objects is determined to be a stationary object and the other of the first and second objects is determined to be a moving object. Consequently, it becomes possible to detect that the fusion object has been outputted by erroneous fusion of a moving object and a stationary object.

When both the first and second conditions are satisfied, it is highly probable that erroneous fusion has actually occurred in situations where the amount of information on the objects is small and thus erroneous fusion is likely to occur. Moreover, when the collision prediction is performed using erroneously-fused objects, a collision may be predicted even though no collision will actually occur; and unnecessary processes may be executed. Therefore, in the present disclosure, when both the first and second conditions are satisfied, the collision prediction unit 150 predicts that the fusion object and the own vehicle will not collide with each other even if the movement trajectory of the fusion object and the movement trajectory of the own vehicle intersect each other. The result of the prediction by the collision prediction unit 150 is transmitted to the driving assistance unit 160.

In addition, when the movement trajectory of the fusion object and the movement trajectory of the own vehicle intersect each other and at least one of the first and second conditions is not satisfied, the collision prediction unit 150 predicts that the fusion object and the own vehicle will collide with each other.

### Function of Driving Assistant Unit 160

When it is predicted by the collision prediction unit 150 that the fusion object and the own vehicle will collide with each other, the driving assistance unit 160 performs at least one of increasing the braking force of the own vehicle and issuing a warning to the driver of the own vehicle. The increasing of the braking force and the issuance of a warning are performed in order to avoid a collision or to suppress the impact at the time of a collision. The increasing of the braking force is realized by transmitting a control signal for increasing the braking force to the braking apparatus 400. The issuance of a warning is realized by transmitting a control signal for causing the warning apparatus 500 to execute a warning. That is, the expression “the driving assistance unit 160 issues a warning to the driver of the own vehicle” in the present disclosure encompasses that the driving assistance unit 160 indirectly issues a warning through the warning apparatus 500.

In addition, when it is predicted by the collision prediction unit 150 that the fusion object and the own vehicle will not collide with each other, the driving assistance unit 160 performs neither of increasing the braking force of the own vehicle and issuing a warning to the driver of the own vehicle.

### Example of Erroneous Fusion

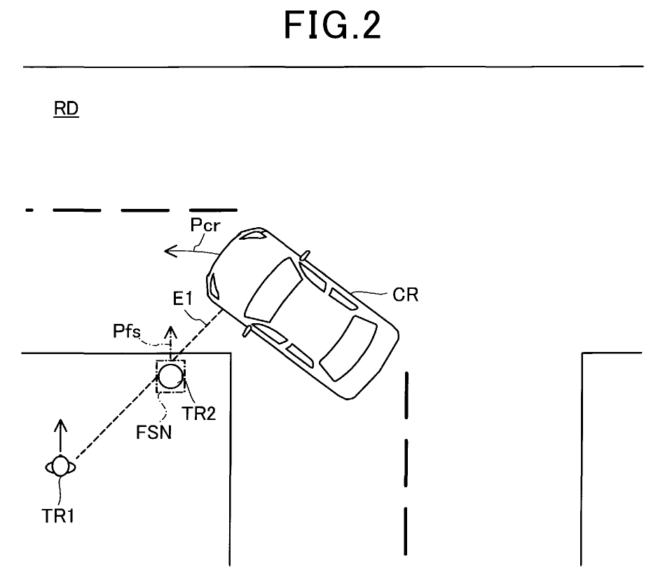

Hereinafter, an example of erroneous fusion will be described with reference to FIG. 2. In the example shown in FIG. 2, the vehicle CR in which the driving assistance apparatus 1 is installed is turning left at an intersection. Moreover, in FIG. 2, there are also illustrated a pedestrian TR1 as a first object and a road sign pole TR2 as a second object. The pedestrian TR1 is walking toward a road RD (i.e., upward in FIG. 2). The pole TR2 is stationary.

In FIG. 2, an edge E1 of the angles of view of the first sensor 11 and the second sensor 12, which are installed in the vehicle CR, is virtually shown by dashed lines. The pedestrian TR1 and the pole TR2 are objects which have entered the angles of view of the first sensor 11 and the second sensor 12 only for a short time with the turning of the vehicle CR and therefore there is only a small amount of available information on these objects. Moreover, as viewed from the first sensor 11 and the second sensor 12, both the pedestrian TR1 and the pole TR2 are located on the same straight line. Accordingly, the fusion unit 110 may erroneously determine the pedestrian TR1 and the pole TR2 to be the same object, and may output a fusion object FSN at the position of the pole TR2. In this case, since the fusion object FSN is obtained by fusing the moving pedestrian TR1 and the stationary pole TR2, the fusion object FSN is detected as moving in the same manner as the pedestrian TR1 from the position of the pole TR2. Consequently, the collision prediction unit 150 determines that the movement trajectory Pfs of the fusion object FSN and the movement trajectory Pcr of the vehicle CR intersect each other. However, in fact, at the position of the fusion object FSN outputted from the fusion unit 110, there exists the stationary pole TR2; and the stationary pole TR2 and the vehicle CR will not collide with each other. As a result, erroneous collision prediction may be made due to erroneous fusion of the objects.

In contrast, according to the present embodiment, when both the first and second conditions are satisfied, i.e., when erroneous fusion of the moving pedestrian TR1 and the stationary pole TR2 has occurred during the turning of the vehicle CR, the collision prediction unit 150 predicts that the fusion object FSN and the vehicle CR will not collide with each other. Consequently, it becomes possible to prevent erroneous prediction from being made by the collision prediction unit 150 due to erroneous fusion of the objects.

### Collision Prediction Process for Fusion Object

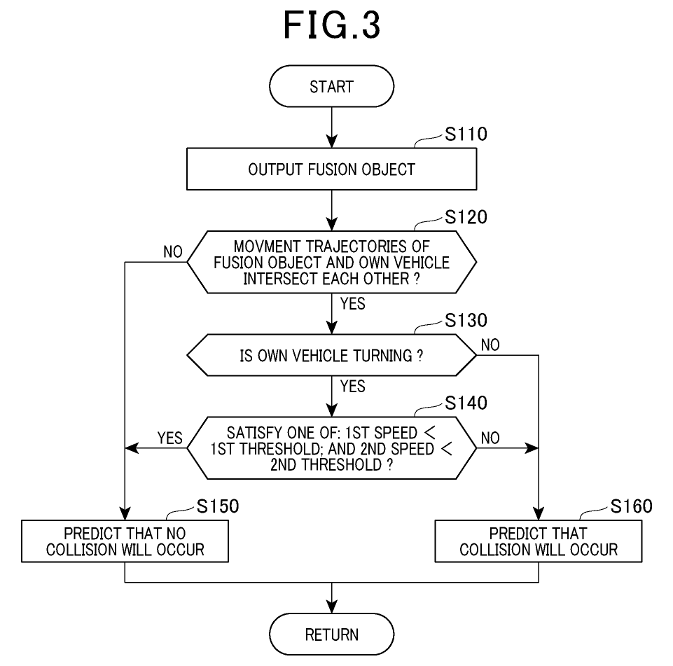

Hereinafter, a collision prediction process performed by the driving assistance apparatus 1 according to the present embodiment for a fusion object will be described with reference to FIG. 3. The collision prediction process is performed when a first object is detected by the first sensor 11 and a second object is detected by the second sensor 12 during traveling of the vehicle in which the driving assistance apparatus 1 is installed. In addition, it is assumed that the first and second objects detected respectively by the first and second sensors 11 and 12 satisfy the predetermined condition for the fusion unit 110 to output a fusion object.

First, in step S110, the fusion unit 110 outputs a fusion object into which the first and second objects detected respectively by the first and second sensors 11 and 12 are fused. Then, in step S120, the collision prediction unit 150 determines whether the movement trajectory of the fusion object outputted from the fusion unit 110 and the movement trajectory of the own vehicle intersect each other.

If the movement trajectory of the fusion object and the movement trajectory of the own vehicle do not intersect each other and thus the determination in step S120 results in a “NO” answer, the process proceeds to step S150. In step S150, the collision prediction unit 150 predicts that the fusion object and the own vehicle will not collide with each other.

In contrast, if the movement trajectory of the fusion object and the movement trajectory of the own vehicle intersect each other and thus the determination in step S120 results in a “YES” answer, the process proceeds to step S130. In step S130, the turning determination unit 140 determines whether the own vehicle is turning.

If the own vehicle is not turning and thus the determination in step S130 results in a “NO” answer, the process proceeds to step S160. In step S160, the collision prediction unit 150 predicts that the fusion object and the own vehicle will collide with each other.

In contrast, if the own vehicle is turning and thus the determination in step S130 results in a “YES” answer, the process proceeds to step S140. In step S140, the speed determination unit 130 determines whether one of the two conditions, i.e., the condition that the first speed is lower than the first threshold and the condition that the second speed is lower than the second threshold, is satisfied. In addition, as described above, the first speed denotes the speed of the first object, whereas the second speed denotes the speed of the second object.

If one of the two conditions is satisfied and thus the determination in step S140 results in a “YES” answer, the process proceeds to step S150. In step S150, the collision prediction unit 150 predicts that the fusion object and the own vehicle will not collide with each other.

In contrast, if the first speed is not lower than the first threshold and the second speed is not lower than the second threshold and thus the determination in step S140 results in a “NO” answer, the process proceeds to step S160. In step S160, the collision prediction unit 150 predicts that the fusion object and the own vehicle will collide with each other.

After completion of either of steps S150 and S160, step S110 is executed again.

According to the present embodiment, it is possible to achieve the following advantageous effects.

In the driving assistance apparatus 1 according to the present embodiment, when (i) it is determined by the turning determination unit 140 that the own vehicle is turning and (ii) it is determined by the speed determination unit 130 that one of the condition that the first speed is lower than the first threshold and the condition that the second speed is lower than the second threshold is satisfied, the collision prediction unit 150 predicts that the fusion object and the own vehicle will not collide with each other even if the movement trajectory of the fusion object and the movement trajectory of the own vehicle intersect each other. Consequently, it becomes possible to prevent, during turning of the own vehicle for which erroneous fusion is likely to occur, an erroneous prediction that the fusion object and the own vehicle will collide with each other.

Moreover, in the driving assistance apparatus 1 according to the present embodiment, the turning determination unit 140 determines, based on at least one of the turning radius, the steering angle and the steering angular velocity of the own vehicle, whether the own vehicle is turning. Consequently, it becomes possible to perform the turning determination based on the detection results of the yaw rate sensor 14 and the steering angle sensor 15 both of which are installed in the own vehicle.

Furthermore, in the driving assistance apparatus 1 according to the present embodiment, when it is predicted by the collision prediction unit 150 that the fusion object and the own vehicle will collide with each other, the driving assistance unit 160 performs at least one of increasing the braking force of the own vehicle and issuing a warning to the driver of the own vehicle. In contrast, when it is predicted by the collision prediction unit 150 that the fusion object and the own vehicle will not collide with each other, the driving assistance unit 160 performs neither of increasing the braking force of the own vehicle and issuing a warning to the driver of the own vehicle. Consequently, when it is predicted by the collision prediction unit 150 that the fusion object and the own vehicle will collide with each other, it is possible to prevent the predicted collision from actually occurring or to reduce the impact caused by the predicted collision. Moreover, when it is predicted by the collision prediction unit 150 that the fusion object and the own vehicle will not collide with each other, it is possible to prevent an unnecessary increase in the braking force of the own vehicle and an unnecessary issuance of a warning to the driver of the own vehicle.

Furthermore, in the present embodiment, the first sensor 11 and the second sensor 12 are constituted of sensors of different types from each other. Specifically, the first sensor 11 is constituted of a camera, whereas the second sensor 12 is constituted of a millimeter-wave radar. Consequently, it becomes possible to detect more information than in the case of the first sensor 11 and the second sensor 12 being constituted of sensors of the same type. More specifically, the detectable ranges and resolutions of sensors differ depending on the types of the sensors. Therefore, more information can be detected by using sensors of different types in combination.

The above-described embodiment can be modified and implemented as follows. Moreover, the above-described embodiment and the following modifications can also be implemented in combination with each other to the extent that there is no technical contradiction between them.

In the above-described embodiment, the turning determination unit 140 may determine not only whether the own vehicle is turning, but also whether the own vehicle is turning at an intersection or traveling along a corner. Moreover, when the own vehicle is determined to be turning at an intersection, the collision prediction unit 150 may predict, if the movement trajectory of the fusion object and the movement trajectory of the own vehicle intersect each other, that the fusion object and the own vehicle will collide with each other regardless of whether the first and second conditions are satisfied. In contrast, when the own vehicle is determined to be traveling along a corner, the collision prediction unit 150 may perform the same process as that performed in the above-described embodiment. That is, when both the first and second conditions are satisfied, the collision prediction unit 150 may predict that the fusion object and the own vehicle will not collide with each other even if the movement trajectory of the fusion object and the movement trajectory of the own vehicle intersect each other.

The determination as to whether the own vehicle is turning at an intersection or traveling along a corner may be performed based on at least one of the turning radius, the steering angle and the steering angular velocity of the own vehicle. When the own vehicle is turning at an intersection, the turning radius is less than that when the own vehicle is traveling along a corner and the steering angle and the steering angular velocity are greater than those when the own vehicle is traveling along a corner. Therefore, the turning determination unit 140 may determine that the own vehicle is turning at an intersection when at least one of the following three conditions is satisfied: (1) the turning radius is less than a predetermined threshold; (2) the steering angle is greater than a predetermined threshold; and (3) the steering angular velocity is higher than a predetermined threshold. With such a configuration, it is possible to prevent occurrence of a collision between the fusion object and the own vehicle when the own vehicle is turning at an intersection; collisions are more likely to occur when the own vehicle is turning at an intersection than when the own vehicle is traveling along a corner.

In the above-described embodiment, the collision prediction unit 150 may predict that the fusion object and the own vehicle will not collide with each other when a third condition is satisfied in addition to the first and second conditions. The third condition is that at least one of the following conditions is satisfied: (a) the first object is detected in an edge portion of the angle of view of the first sensor 11; and (b) the second object is detected in an edge portion of the angle of view of the second sensor 12. It should be noted that the term “an edge portion of the angle of view” herein may denote, for example, a portion extending from either of two edges of the angle of view for substantially 10% of the width of the angle of view in a width direction of the angle of view. With such a configuration, it is possible to determine erroneous fusion focusing on objects detected in edge portions of the angles of view of the first and second sensors 11 and 12; there is only a small amount of available information on these objects.

In the above-described embodiment, the turning determination unit 140 determines whether the own vehicle is turning based on at least one of the turning radius, the steering angle and the steering angular velocity of the own vehicle. However, the present disclosure is not limited to this determination method. That is to say, the turning determination unit 140 may determine whether the own vehicle is turning by any suitable methods. For example, the turning determination unit 140 may determine whether the own vehicle is turning based on the detection results of the first sensor 11 and the second sensor 12. That is, the turning determination unit 140 may determine whether the own vehicle is turning based on the relative positional relationship between the own vehicle and objects around the own vehicle.

In the above-described embodiment, the first sensor 11 and the second sensor 12 are constituted of sensors of different types from each other. However, the present disclosure is not limited to this configuration. Alternatively, the first sensor 11 and the second sensor 12 may be constituted of sensors of the same type. With such a configuration, calibration of the first sensor 11 and the second sensor 12 can be facilitated in comparison with the configuration in which the first sensor 11 and the second sensor 12 are constituted of sensors of different types from each other.

In the above-described embodiment, the driving assistance apparatus 1 is installed in a vehicle. However, the present disclosure is not limited to this application. That is to say, the driving assistance apparatus 1 may be applied to any mobile objects. In addition, examples of mobile objects include a ship, an aircraft, and a so-called flying car.

The driving assistance apparatus 1 and the driving assistance methods described in the present disclosure may be realized by a dedicated computer that includes a processor, which is programmed to perform one or more functions embodied by a computer program, and a memory. As an alternative, the driving assistance apparatus 1 and the driving assistance methods described in the present disclosure may be realized by a dedicated computer that includes a processor configured with one or more dedicated hardware logic circuits. As another alternative, the driving assistance apparatus 1 and the driving assistance methods described in the present disclosure may be realized by one or more dedicated computers configured with a combination of a processor programmed to perform one or more functions, a memory and a processor configured with one or more dedicated hardware logic circuits. In addition, the computer program may be stored as computer-executable instructions in a computer-readable non-transitory tangible storage medium.

The present disclosure is not limited to the above-described embodiment and modifications, and can be implemented in various configurations without departing from the spirit of the present disclosure. Moreover, the present disclosure may be implemented, for example, in the forms of a collision prediction method, a computer program for realizing such a method, and a non-transitory storage medium having such a computer program stored therein.

The following notes summarize the technical ideas derived from the present disclosure.

### First Note

A driving assistance apparatus (1) for a mobile object, the mobile object having a first sensor (11) and a second sensor (12) configured to detect objects around the mobile object, the driving assistance apparatus (1) comprising:

a fusion unit (110) configured to fuse a first object detected by the first sensor and a second object detected by the second sensor and output a fusion object into which the first and second objects are fused;

a speed calculation unit (120) configured to calculate both a first speed that is a speed of the first object and a second speed that is a speed of the second object;

a speed determination unit (130) configured to determine whether the first speed is lower than a first threshold that is a predetermined threshold and determine whether the second speed is lower than a second threshold that is another predetermined threshold;

a turning determination unit (140) configured to determine whether the mobile object is turning; and

a collision prediction unit (150) configured to predict, based on a movement trajectory of the fusion object outputted from the fusion unit (110) and a movement trajectory of the mobile object, whether a collision will occur between the fusion object and the mobile object,

wherein

when (i) it is determined by the turning determination unit (140) that the mobile object is turning and (ii) it is determined by the speed determination unit (130) that one of a condition that the first speed is lower than the first threshold and a condition that the second speed is lower than the second threshold is satisfied, the collision prediction unit (150) predicts that the fusion object and the mobile object will not collide with each other even if the movement trajectory of the fusion object and the movement trajectory of the mobile object intersect each other.

### Second Note

The driving assistance apparatus according to the first note, wherein

the turning determination unit (140) determines, based on at least one of a turning radius, a steering angle and a steering angular velocity of the mobile object, whether the mobile object is turning.

### Third Note

The driving assistance apparatus according to the first or second note, further comprising a driving assistance unit (160), wherein:

when it is predicted by the collision prediction unit (150) that the fusion object and the mobile object will collide with each other, the driving assistance unit (160) performs at least one of increasing a braking force of the mobile object and issuing a warning to a driver of the mobile object; and

when it is predicted by the collision prediction unit (150) that the fusion object and the mobile object will not collide with each other, the driving assistance unit (160) performs neither of increasing the braking force of the mobile object and issuing a warning to the driver of the mobile object.

### Fourth Note

The driving assistance apparatus according to any one of the first to third notes, wherein

the first sensor (11) and the second sensor (12) are constituted of sensors of different types from each other.

### Fifth Note

The driving assistance apparatus according to any one of the first to third notes, wherein

the first sensor (11) and the second sensor (12) are constituted of sensors of the same type.

### DESCRIPTION OF REFERENCE SIGNS

1: driving assistance apparatus; 11: first sensor; 12: second sensor; 13: vehicle speed sensor; 14: yaw rate sensor; 15: steering angle sensor; 100: processor; 110: fusion unit; 120: speed calculation unit; 130: speed determination unit; 140: turning determination unit; 150: collision prediction unit; 160: driving assistance unit; 200: memory; 300: input/output interface; 400: braking apparatus; 500: warning apparatus; CR: vehicle; E1: edge; FSN: fusion object; Pcr: movement trajectory of vehicle; Pfs: movement trajectory of fusion object; RD: road; TR1: pedestrian; TR2: pole.

What is claimed is:

1. A driving assistance apparatus for a mobile object, the mobile object having a first sensor and a second sensor configured to detect objects around the mobile object, the driving assistance apparatus comprising:
a fusion unit configured to fuse a first object detected by the first sensor and a second object detected by the second sensor and output a fusion object into which the first and second objects are fused;
a speed calculation unit configured to calculate both a first speed that is a speed of the first object and a second speed that is a speed of the second object;
a speed determination unit configured to determine whether the first speed is lower than a first threshold that is a predetermined threshold and determine whether the second speed is lower than a second threshold that is another predetermined threshold;
a turning determination unit configured to determine whether the mobile object is turning; and
a collision prediction unit configured to predict, based on a movement trajectory of the fusion object outputted from the fusion unit and a movement trajectory of the mobile object, whether a collision will occur between the fusion object and the mobile object,
wherein
when (i) it is determined by the turning determination unit that the mobile object is turning and (ii) it is determined by the speed determination unit that one of a condition that the first speed is lower than the first threshold and a condition that the second speed is lower than the second threshold is satisfied, the collision prediction unit predicts that the fusion object and the mobile object will not collide with each other even if the movement trajectory of the fusion object and the movement trajectory of the mobile object intersect each other.

2. The driving assistance apparatus as set forth in claim 1, wherein
the turning determination unit determines, based on at least one of a turning radius, a steering angle and a steering angular velocity of the mobile object, whether the mobile object is turning.

3. The driving assistance apparatus as set forth in claim 1, further comprising a driving assistance unit, wherein:
when it is predicted by the collision prediction unit that the fusion object and the mobile object will collide with each other, the driving assistance unit performs at least one of increasing a braking force of the mobile object and issuing a warning to a driver of the mobile object; and
when it is predicted by the collision prediction unit that the fusion object and the mobile object will not collide with each other, the driving assistance unit performs neither of increasing the braking force of the mobile object and issuing a warning to the driver of the mobile object.

4. The driving assistance apparatus as set forth in claim 1, wherein
the first sensor and the second sensor are constituted of sensors of different types from each other.

5. The driving assistance apparatus as set forth in claim 1, wherein
the first sensor and the second sensor are constituted of sensors of the same type.

6. A driving assistance apparatus for a mobile object, the mobile object having a first sensor and a second sensor configured to detect objects around the mobile object, the driving assistance apparatus comprising a processor configured to:
fuse a first object detected by the first sensor and a second object detected by the second sensor into a fusion object;
calculate both a first speed that is a speed of the first object and a second speed that is a speed of the second object;
determine whether the first speed is lower than a first threshold that is a predetermined threshold and determine whether the second speed is lower than a second threshold that is another predetermined threshold;
determine whether the mobile object is turning; and
predict, based on a movement trajectory of the fusion object and a movement trajectory of the mobile object, whether a collision will occur between the fusion object and the mobile object,
wherein
the processor is further configured to predict, when (i) it is determined that the mobile object is turning and (ii) it is determined that one of a condition that the first speed is lower than the first threshold and a condition that the second speed is lower than the second threshold is satisfied, that the fusion object and the mobile object will not collide with each other even if the movement trajectory of the fusion object and the movement trajectory of the mobile object intersect each other.

7. The driving assistance apparatus as set forth in claim 6, wherein
the processor is configured to execute a computer program stored in a non-transitory storage medium, or is configured with one or more dedicated hardware logic circuits.
